(19) United States
(12) Patent Application Publication
(10) Pub. No.: US 2011/0236662 A1
(43) Pub. Date: Sep. 29, 2011

(54) INSULATING FILM AND FLAT CABLE USING THE SAME

(76) Inventors: Yutaka Fukuda, OSAKA (JP); Hiroshi Hayami, Osaka (JP); Tatsuji Oku, Tochigi (JP)

(21) Appl. No.: 13/132,047

(22) PCT Filed: Jul. 22, 2010
(86) PCT No.: PCT/JP2010/062329

§ 371 Date: May 31, 2011

(30) Foreign Application Priority Data
Jul. 31, 2009 (JP) 2009-178518

(51) Int. Cl. B32B 7/02; B32B 27/32; B32B 27/08; D02G 3/36

(52) U.S. Cl. 428/216; 428/523; 428/375

(57) ABSTRACT

An insulating film having good thermal resistance and flame retardance, flexibility, and good wiring property and a flat cable that uses such an insulating film are provided.

An insulating film includes a resin film, an anchor coat layer, and a flame-retardant resin layer stacked in that order. The flame-retardant resin layer is composed of a resin composition that contains 60 parts by mass or more and 240 parts by mass or less of a flame retardant-imparting agent relative to 100 parts by mass of a polypropylene resin having a flexural modulus of 100 MPa or more and less than 900 MPa on the basis of JIS K7171.

### TECHNICAL FIELD

The present invention relates to an insulating film for use as a coating material of a flat cable, and a flat cable using the same.

### BACKGROUND ART

Multicore-type flat cables have been used as wires for internal wiring for electronic appliances. A flat cable is produced by sandwiching a plurality of conductors aligned side-by-side between two insulating films and integrating them by thermally bonding the insulating films. The insulating films generally have an adhesive layer in contact with the conductors and a resin film on the outer side thereof. As the resin film, biaxially stretched polyethylene terephthalate (PET) films that have good mechanical and electrical properties are widely used.

Some usages of flat cables require a high degree of flame retardance, and flame retardance is regulated by, e.g., a Vertical-Specimen-Flame test (VW-1 test) according to an American UL standard. In order to satisfy the standard for flame retardance, flame retardants such as halogen-based flame retardants, phosphorus-based flame retardants, and non-halogen-based flame retardants are added to the adhesive layer. For example, PTL 1 discloses a coating material for a flat cable, in which a flame retardant olefin-based resin film is stacked on an insulating base film and an olefin-based thermobonding resin film is stacked on the flame-retardant olefin-based resin film, and a flat cable that uses the coating material. A resin film to which flame retardance is imparted by blending a flame retardant to low-density polyethylene or the like is used as the flame-retardant-olefin-based resin film.

PTL 2 discloses a tape for a flat cable, in which a film-shaped substrate, an anchor coat layer, and a heat seal layer are sequentially stacked, and a resin composition containing a polyester-based resin and a flame retardant is used as the heat seal layer.

### CITATION LIST

### Patent Literature

PTL 1: Japanese Unexamined Patent Application Publication No. 7-262834
PTL 2: Japanese Unexamined Patent Application Publication No. 2001-222919

### SUMMARY OF INVENTION

### Technical Problem

Flat cables used in applications exposed to high-temperature during use, such as internal wiring of automobiles, are required to have heat resistant, i.e., properties that do not deteriorate when left at high temperature for a long period of time. From the viewpoint of workability for wiring, flexibility is also required. This is because flat cables having poor flexibility, i.e., hard flat cables, cannot be freely bent during wiring and extra force is required.

The low-density polyethylene used as the adhesive layer of the flat cable described in PTL 1 has a disadvantage that its heat resistance is low. Moreover, since a film-shaped flame-retardant olefin-based resin film is stacked on the base film in advance, the thickness of the flame-retardant olefin-based resin film cannot be decreased when the handleability of the film is considered, and the flexibility is also degraded.

Although the polyester-based resin used in PTL 2 is flexible, the viscosity tends to be low at high temperatures. Thus, there is a problem that the resin softens and flows out of the flat cable when left under high temperature conditions for a long period of time. Moreover, polyester-based resins are easily hydrolyzable and degrade thermal resistance and moisture resistance.

In order to improve the thermal resistance of resins, resins may be cross-linked by irradiation with ionizing radiation. However, irradiation cross-linking may result in deterioration of the base film and thus a decrease in mechanical strength of the flat cable. Moreover, since a step of irradiation cross-linking is added, the production cost will rise.

An object of the present invention is to provide an insulating film that has good thermal resistance and flame retardance, is flexible, and has good workability for wiring, and a flat cable using the insulating film.

### Solution to Problem

The present invention provides an insulating film including a resin film, an anchor coat layer, and a flame-retardant resin layer stacked in that order, in which the flame-retardant resin layer is composed of a resin composition that contains 60 parts by mass or more and 240 parts by mass or less of a flame retardant-imparting agent relative to 100 parts by mass of a polypropylene resin having a flexural modulus of 100 MPa or more and less than 900 MPa on the basis of JIS K7171 (first invention of the subject application).

Both flexibility and thermal resistance can be achieved when a polypropylene resin having a flexural modulus of 100 MPa or more and less than 900 MPa is used as the resin contained in the flame-retardant resin layer. An insulating film that has high flame retardance and that can pass the Vertical-Specimen-Flame test (VW-1 test) of UL standard can be obtained when 60 parts by mass or more and 240 parts by mass or less of a flame retardant-imparting agent is contained relative to 100 parts by mass of the polypropylene resin.

Preferably, a first resin layer is provided between the anchor coat layer and the flame-retardant resin layer (second invention of the subject application). Formation of the flame-retardant resin layer is often conducted by an extrusion technique. When a resin composition for forming the flame-retardant resin layer and a resin composition for forming the first resin layer are co-extruded, generation of die lip buildups during the extrusion process can be suppressed and the extrusion processability can be improved.

Preferably, a second resin layer is provided on the flame-retardant resin layer (third invention of the subject application). When a second resin layer is provided on the flame-retardant resin layer, the extrusion processability can be further improved. When a resin having high adhesiveness to a conductor is used as the second resin layer, the adhesiveness between the insulating film and the conductor can be improved. The first resin layer and the second resin layer may be composed of the same material or different materials.

The second resin layer preferably contains an acid-modified polypropylene resin as a main component (fourth invention of the subject application). An acid-modified polypropylene resin barely absorbs water or undergoes hydrolysis and has high thermal and moisture resistance and adhesion to the conductor.

The first resin layer and the second resin layer each preferably have a thickness of 1 or more and 10 μm or less (fifth invention of the subject application). If the thickness of the first and second resin layer is less than 1 μm, the effect of improving the extrusion processability is diminished. In contrast, when the thickness exceeds 10 μm, the thickness of the entire insulating film is increased and thus the flexibility is lowered.

The present invention also provides a flat cable that uses the insulating film as a coating material (sixth invention of the subject application). The flat cable has good thermal resistance and flame retardance and flexibility.

### Advantageous Effects of Invention

According to the present invention, an insulating film having good thermal resistance and flame retardance and flexibility and a flat cable using the insulating film can be obtained. The flat cable is suitable for use in high-temperature atmospheres, such as wiring inside automobiles, etc.

### BRIEF DESCRIPTION OF DRAWINGS

FIG. 1 is a cross-sectional view of an insulating film of the present invention.

FIG. 2 is a diagram of a flat cable of the present invention.

FIG. 3 is a cross-sectional view of the flat cable of the present invention taken along line A-A′ in FIG. 2.

### DESCRIPTION OF EMBODIMENTS

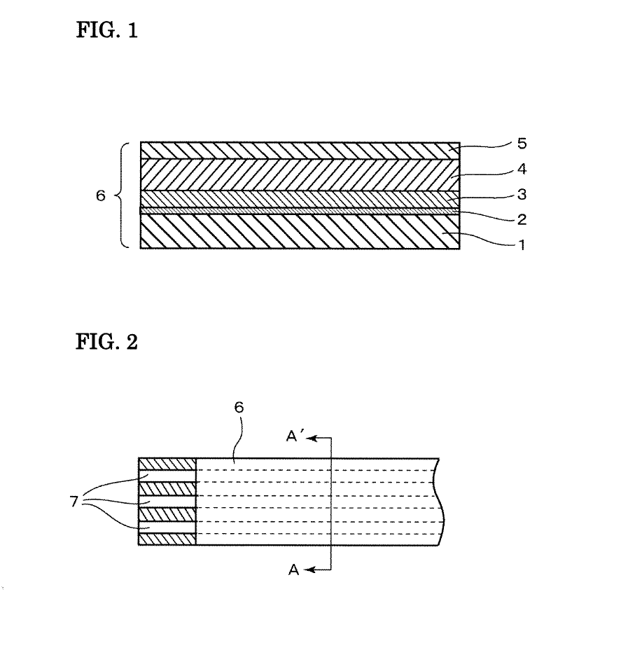

FIG. 1 is a cross-sectional view showing one example of an insulating film according to the present invention. A resin film 1, an anchor coat layer 2, a first resin layer 3, a flame-retardant resin layer 4, and a second resin layer 5 are stacked in that order. The first resin layer 3 and the second resin layer 5 are optional. The insulating film is slit into a desired shape and used.

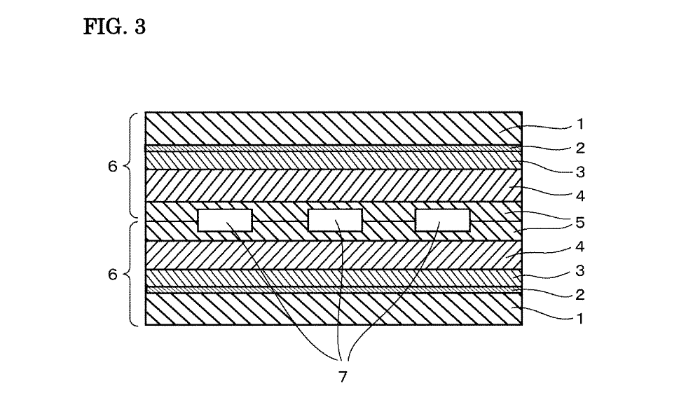

FIG. 2 is a diagram showing a flat cable that uses the insulating film of the present invention. FIG. 3 is a cross-sectional view taken along line A-A′ in FIG. 2. Two insulating films 6 are bonded to each other while sandwiching conductors 7 between the two insulating films 6. In FIG. 3, the second resin layer 5 is in contact with the conductors 7. When no second resin layer 5 is provided, the flame-retardant resin layer 4 is in contact with the conductors 7.

As shown in FIG. 2, at an end of the flat cable, the conductors 7 are exposed by providing the insulating film on only one side so that the conductors 7 can be connected to connecting terminals provided in an electronic appliance.

A highly flexible resin material is used as the resin film 1. Examples thereof include polyester resins, polyphenylene sulfide resins, and polyimide resins. Examples of the polyester resins include polyethylene terephthalate resin, polybutylene terephthalate resin, polyethylene naphthalate resin, polybutylene naphthalate resin, polytrimethylene terephthalate resin, polytrimethylene naphthalate resin, polycyclohexane dimethyl terephthalate resin, and polycyclohexane dimethyl naphthalate polyarylate resin.

Of these resins, polyethylene terephthalate resin is preferably used as the resin film from the viewpoints of electrical properties, mechanical properties, cost, etc. The thickness of the resin film is preferably 12 to 50 μm.

The anchor coat layer is used to improve the adhesion between the resin film 1 and the flame-retardant resin layer 4 or the first resin layer 3. The material for the anchor coat layer may be any. For example, a urethane-based anchor coat material in which an isocyanate-based curing agent is mixed with a polyurethane resin as the base resin is preferably used. The thickness of the anchor coat layer is preferably 0.5 to 5 μm.

Any resin may be used as the first resin layer and a resin having good thermal and moisture resistance is preferably used. Examples of the resin having good thermal and moisture resistance include polypropylene resin, acid-modified polypropylene resin, and acid-modified polyethylene resin.

Any resin may be used as the second resin layer and a resin having good thermal and moisture resistance is preferably used. Examples of the resin having good thermal and moisture resistance include polypropylene resin, acid-modified polypropylene resin, and acid-modified polyethylene resin. Acid-modified polypropylene resin is preferably used from the viewpoint of increasing the adhesiveness to the conductors.

Examples of the acid-modified polypropylene resin include maleic anhydride-modified polypropylene resin, acrylic acid-modified polypropylene resin, and itaconic acid-modified polypropylene resin. Polypropylene resin modified by a functional group such as an epoxy group, a hydroxy group, a carboxyl group, an amino group, or the like can also be used. An acid-modified polypropylene resin having a melting point of 105° C. to 155° C. is preferably used considering the thermal resistance and adhesion.

The first resin layer and the second resin layer may each use these resins alone or in combination with various additives such as an antioxidant or another resin. The first resin layer and the second resin layer may be composed of the same material or different materials.

The flame-retardant resin layer is used to improve the flame retardance of the flat cable. The resin composition used in the flame-retardant resin layer contains as a main component a polypropylene resin having a flexural modulus of 100 MPa or more and less than 900 MPa based on JIS K7171. The flame-retardant resin layer becomes hard if the flexural modulus is 900 MPa or more, and thus the flexibility of the insulating film and the flat cable is deteriorated. If the flexural modulus is less than 100 MPa, the flame-retardant resin layer becomes excessively soft, and the thermal resistance and the strength are degraded. Polypropylene resin has good thermal resistance and the required thermal and moisture resistance can be obtained without irradiation cross-linking.

Either one of a propylene homopolymer and a copolymer (random copolymer or block copolymer) of propylene and ethylene may be used as the polypropylene resin. A modified polypropylene resin such as an acid-modified polypropylene resin and a resin (elastomer-modified polypropylene resin) obtained by mixing a styrene-based elastomer such as SEBS or an olefin-based thermoplastic elastomer with polypropylene can also be used. In this description, those modified polypropylene resins are also described as polypropylene resin. These resins are used alone or in combination. When two or more resins are used in combination, the flexural modulus of the resin obtained by mixing is adjusted within the range of 100 MPa or more and less than 900 MPa.

The resin composition used in the flame-retardant resin layer contains 60 parts by mass or more and 240 parts by mass or less of the flame retardant-imparting agent relative to 100 parts by mass of the polypropylene resin described above. When the amount of the flame retardant-imparting agent is less than 60 parts by mass, the flame retardance satisfying the UL standard is not obtained. When the amount of the flame retardant-imparting agent is more than 240 parts by mass, the film-processing property and adhesiveness of the flame-retardant resin layer are degraded. A halogen-based flame retardant, a phosphorus-based flame retardant, a non-halogen-based flame retardant, or the like may be used as the flame retardant-imparting agent.

Examples of the halogen-based flame retardant include chlorine-based flame retardants such as chlorinated paraffin, chlorinated polyethylene, chlorinated polyphenol, and perchloropentacyclodecane; and bromine-based flame retardants such as ethylenebispentabromodiphenyl, tetrabromoethane, tetrabromobisphenol A, hexabromobenzene, decabromobiphenyl ether, tetrabromophthalic anhydride, polydibromophenylene oxide, hexabromocyclodecane, and ammonium bromide.

Examples of the phosphorus-based flame retardants include cyclic organic phosphorus compounds such as 9,10-dihydro-9-oxa-10-phosphaphenanthrene-10-oxide, triallyl phosphate, alkyl aryl phosphate, alkyl phosphate, dimethyl phosphonate, phosphorinate, halogenated phosphorinate ester, trimethyl phosphate, tributyl phosphate, trioctyl phosphate, tributoxyethyl phosphate, octyldiphenyl phosphate, tricresyl phosphate, cresylphenyl phosphate, triphenyl phosphate, tris(chloroethyl) phosphate, tris(2-chloropropyl) phosphate, tris(2,3-dichloropropyl) phosphate, tris(2,3-dibromopropyl) phosphate, tris(bromochloropropyl) phosphate, bis(2,3-dibromopropyl)-2,3-dichloropropyl phosphate, bis(chloropropyl)monooctyl phosphate, polyphosphonate, polyphosphate, phosphonate-type polyol, and phosphate-type polyol.

Examples of the non-halogen flame retardants include metal oxides and metal hydroxides such as aluminum hydroxide, magnesium hydroxide, and magnesium carbonate, and nitrogen compounds such as melamine cyanurate, triazine, isocyanurate, urea, and guanidine.

Of these flame retardants, a halogen-based flame retardant such as a bromine-based flame retardant or a chlorine-based flame retardant is preferably used to improve the flame retardance. These flame retardants may be used alone or in combination of two or more. A halogen-based flame retardant is preferably used in combination with a flame retarding aid to further improve the flame retardance. In the present invention, both flame retarding aids and flame retardants are referred to as flame retardant-imparting agents. Antimony trioxide is preferably used as the flame retarding aid.

In addition to the materials described above, an antioxidant, a coloring agent, a masking agent, a hydrolysis suppressor, a lubricant, a process stabilizer, a plasticizer, a foaming agent, etc., may be added to the flame-retardant resin layer. Other resin components may also be added as long as the essential features of the present invention are not impaired. These materials may be mixed by using any machine, such as a single shaft mixer, a twin shaft mixer, a three roller, or the like.

The insulating film of the present invention is obtained by stacking at least the resin film, the anchor coat layer, and the flame-retardant resin layer described above. A first resin layer may be provided between the anchor coat layer and the flame-retardant resin layer. A second resin layer may be provided on the flame-retardant resin layer. The resin film may be produced by, for example, forming a three-layer laminated film by co-extruding the first resin layer, the flame-retardant resin layer, and the second resin layer by melting extrusion, and then stacking the laminated film on a resin film provided with the anchor coat layer. According to this method, thermal contraction of the resin layer can be reduced during thermal lamination, and the insulating film can be prevented from curling. Alternatively, the first resin layer, the flame-retardant resin layer, and the second resin layer may be stacked on the resin film provided with the anchor coat layer by a technique such as melt extrusion.

In producing a flat cable, two insulating films 6 are positioned on the outer sides of conductors 7 so as to oppose each other with resin films 1 facing outward, and the conductors 7 are bonded with the insulating films 6 and the insulating films 6 are bonded with each other through a heating and pressurizing process by using a known thermal laminator or a thermal press machine. During this process, a hole is formed in part of the insulating films 6 in a portion that forms an end of the flat cable so that the conductors 7 at the end can be exposed. A long flat cable can be obtained by continuously performing thermal lamination or thermal pressing. Then the cable is cut into a predetermined length to obtain a flat cable having a desired length.

An electrically conductive metal such as copper, tin-plated annealed copper, or nickel-plated annealed copper can be used as the conductors. The conductors preferably have a flat rectangular shape. Although the thickness depends on the amount of current used, the thickness is preferably 15 μm to 100 μm considering the flexibility of the flat cable.

### EXAMPLES

The present invention will now be described by using Examples and Comparative Examples. Note that Examples do not limit the scope of the present invention.

### Example 1

### Preparation of Resin Composition

To 100 parts by mass of a polypropylene (product of Japan Polypropylene Corporation, trade name: NOVATEC FW4BT) having a flexural modulus based on JIS K 7171 (hereinafter referred to as “flexural modulus”) of 850 MPa, 60 parts of a bromine-based flame retardant (product of Albemarle Corporation, trade name: SAYTEX 8010) and 20 parts by mass of antimony trioxide were added, and the mixture was homogeneously mixed using a twin shaft mixer to prepare a resin composition.

### (Preparation of Insulating Film)

The resin composition prepared and a polypropylene resin (product of Japan Polypropylene Corporation, trade name: NOVATEC FX4E, flexural modulus: 650 MPa) for forming first and second resin layers were co-extruded through a T die to form a three-layer laminated film including a first resin layer (thickness: 5 μm), a flame-retardant resin layer (thickness: 30 μm), and a second resin layer (thickness: 5 μm). Then an anchor coat agent was prepared by mixing an ethyl acetate solution of a polyurethane resin (product of Mitsui Chemical Polyurethane Inc., trade name: TAKELAC A-310) and an ethyl acetate solution of an isocyanate-based curing agent (product of Mitsui Chemical Polyurethane Inc., trade name: TAKENATE A-3) in a ratio of 100:15 on a solid content basis. The anchor coat agent was applied on a corona-treated surface of a polyethylene terephthalate resin film (product of Teijin DuPont Films Japan Limited, thickness: 25 μm) and dried to remove the solvent. An anchor coat layer having a thickness of 3 μm was thereby formed on the surface of the resin film.

The three-layer laminated film was superimposed on the anchor coat layer-side of the resin film and heat and pressure were applied (dry lamination) using a thermal roller heated to 60° C. so as to form an insulating film having the first resin layer, the flame-retardant resin layer, and the second resin layer laminated on the surface of the anchor coat layer.

### (Preparation of Flat Cable)

Eight pieces of tin-plated annealed copper foil (35 μm in thickness, 1.5 mm in width) serving as conductors were arranged to be parallel to each other at intervals of 2.5 mm, sandwiched between two insulating films, and heated and pressurized using a thermal laminator heated to 130° C. to coat both sides of the conductors with the insulating films. Then the coated conductors were cut into a desired length to prepare a flat cable.

### (Evaluation of Flexibility)

The flat cable prepared was cut to a length of about 100 mm and formed into a ring having a diameter of 30 mm. The strength needed to reduce the diameter of the ring by 50% was measured. If the flat cable is hard, the compressive strength is high. If the flat cable is flexible, the compressive strength is low and the flat cable can be easily bent. A flat cable was evaluated as having good flexibility when the strength was 50 g or less.

### (Evaluation of Thermal Resistance)

The flat cable prepared was folded in two and left in a thermostat oven at 140° C. for 7 days. Then whether overflowing of the adhesive and separation of the insulating layers occurred was observed with naked eye. A sample having good appearance after being left in the oven was indicated by a circular symbol (o) and a sample having poor appearance such as overflow of the adhesive and/or separation of the insulating layers was indicated by a cross symbol (x).

### (Evaluation of Flame Retardance)

The flat cable prepared was subjected to Vertical-Specimen-Flame test according to VW-1 of UL standard 1581. In particular, ten flat cables were prepared and ignited. Rating of “fail” was given when one or more of the ten flat cables were burnt, when cotton placed below the flat cable was burnt due to droplets, or when craft paper installed above the flat cable was burnt. Other samples were rated “pass”.

### Example 2

A flat cable was prepared and evaluated as in Example 1 except that the resin composition used in the flame-retardant resin layer was a resin composition containing 100 parts by mass of a polypropylene resin (product of Japan Polypropylene Corporation, trade name: WELNEX RFG4VA) having a flexural modulus of 250 MPa, 60 parts by mass of bromine-based flame retardant (product of Albemarle Corporation, trade name: SAYTEX 8010), and 20 parts by mass of antimony trioxide, a maleic acid-modified polypropylene (product of Mitsui Chemical Inc., trade name: ADMER QF551) was used in the first resin layer, and a polypropylene resin (product of Japan Polypropylene Corporation, trade name: NOVATEC FG3DC) having a flexural modulus of 1050 MPa was used in the second resin layer.

### Example 3

A flat cable was prepared and evaluated as in Example 1 except that the resin composition used in the flame-retardant resin layer was a resin composition containing 100 parts by mass of a polypropylene resin (product of Japan Polypropylene Corporation, trade name: WELNEX RFG4VA) having a flexural modulus of 250 MPa, 60 parts by mass of bromine-based flame retardant (product of Albemarle Corporation, trade name: SAYTEX 8010), and 20 parts by mass of antimony trioxide, and a maleic acid-modified polypropylene (product of Mitsui Chemical Inc., trade name: ADMER QF551) was used in the first and second resin layers.

### Example 4

A flat cable was prepared and evaluated as in Example 1 except that the resin composition used in the flame-retardant resin layer was a resin composition containing 100 parts by mass of a resin (flexural modulus after mixing: 200 MPa) obtained by mixing a polypropylene resin (product of Japan Polypropylene Corporation, trade name: NOVATEC FW4BT) having a flexural modulus of 850 MPa with an olefin-based thermoplastic elastomer (Product of Sumitomo Chemical Co., Ltd., trade name: Tafthren T3722), 60 parts by mass of bromine-based flame retardant (product of Albemarle Corporation, trade name: SAYTEX 8010), and 20 parts by mass of antimony trioxide.

### Example 5

A flat cable was prepared and evaluated as in Example 1 except that the resin composition used in the flame-retardant resin layer was a resin composition containing 100 parts by mass of a polypropylene resin (product of Japan Polypropylene Corporation, trade name: WELNEX RFG4VA) having a flexural modulus of 250 MPa, 100 parts of magnesium hydroxide (product of Kyowa Chemical Industry Co., Ltd., trade name: KISUMA 5A), and 50 parts by mass of a cyclic phosphorus compound (SANKO LTD., HCA-HQ-HS) and melamine cyanurate (product of Nissan Chemical Industries, Ltd., trade name: MC860), a maleic acid-modified polypropylene (product of Mitsui Chemical Inc., trade name: ADMER QF551) was used in the first resin layer, and a polypropylene resin (product of Japan Polypropylene Corporation, trade name: NOVATEC FG3DC) having a flexural modulus of 1050 MPa was used in the second resin layer.

### Comparative Example 1

A flat cable was prepared and evaluated as in Example 1 except that the resin composition used in the flame-retardant resin layer was a resin composition containing 100 parts by mass of a polypropylene resin (product of Japan Polypropylene Corporation, trade name: NOVATEC FB3HAT) having a flexural modulus of 1700 MPa, 60 parts by mass of bromine-based flame retardant (product of Albemarle Corporation, trade name: SAYTEX 8010), and 20 parts by mass of antimony trioxide, a maleic acid-modified polypropylene (product of Mitsui Chemical Inc., trade name: ADMER QF551) was used in the first resin layer, and a polypropylene resin (product of Japan Polypropylene Corporation, trade name: NOVATEC FX4E) having a flexural modulus of 650 MPa was used in the second resin layer.

### Comparative Example 2

A flat cable was prepared and evaluated as in Example 1 except that the resin composition used in the flame-retardant resin layer was a resin composition containing 100 parts by mass of a polypropylene resin (product of UNITIKA LTD., trade name: elitel 3220, softening point: 60° C.), 60 parts by mass of bromine-based flame retardant (product of Albemarle Corporation, trade name: SAYTEX 8010), and 20 parts by mass of antimony trioxide, a polyester resin (product of UNITIKA LTD., trade name: elitel 3400, softening point: 40° C.) was used in the first and second resin layers, and the first resin layer, the flame-retardant resin layer, and the second resin layer were stacked in that order on a resin film provided with an anchor coat layer. Each layer was formed by applying a solution of a resin in a solvent and removing the solvent by drying.

### Comparative Example 3

A flat cable was prepared and evaluated as in Example 1 except that the resin composition used in the flame-retardant resin layer was a resin composition containing 100 parts by mass of a 50:50 (mass) resin mixture (flexural modulus after mixing: 80 MPa) of a polypropylene resin (product of Japan Polypropylene Corporation, trade name: NOVATEC FW4BT) having a flexural modulus of 850 MPa and an olefin-based thermoplastic elastomer (product of Mitsui Chemical Inc., trade name: TAFMER A-1050S), 60 parts by mass of bromine-based flame retardant (product of Albemarle Corporation, trade name: SAYTEX 8010), and 20 parts by mass of antimony trioxide. The results are shown in Table.

| | | | | | | | Comparative | Comparative | Comparative |
|---|---|---|---|---|---|---|---|---|---|
| | | Example 1 | Example 2 | Example 3 | Example 4 | Example 5 | Example 1 | Example 2 | Example 3 |
| Insulating | First resin layer | PP | Maleic | Maleic | PP | Maleic | PP | Polyester | PP |
| Film | | | acid- | acid- | | acid- | | | |
| configuration | | | modified | modified | | modified | | | |
| | | | PP | PP | | PP | | | |
| | Flexural modulus | 850 | 250 | 250 | 200 | 250 | 1700 | — | 80 |
| | (MPa) of resin | | | | | | | | |
| | used in flame- | | | | | | | | |
| | retardant resin | | | | | | | | |
| | Second resin layer | PP | PP | Maleic | PP | PP | PP | Polyester | PP |
| | | | | acid- | | | | | |
| | | | | modified | | | | | |
| | | | | PP | | | | | |
| Evaluation | Flexibility (g) | 45 | 30 | 35 | 40 | 48 | 60 | 30 | 20 |
| results | Thermal resistance | ◯ | ◯ | ◯ | ◯ | ◯ | ◯ | X | X |
| | Flame retardance | Pass | Pass | Pass | Pass | Pass | Pass | Pass | Pass |

In Examples 1 to 5 in which a polypropylene resin having a flexural modulus of 100 MPa or more and 900 MPa or less was used in the flame-retardant resin layer, the bending strength, i.e., a parameter for flexibility, was 50 g or less, showing good flexibility as well as high thermal resistance and flame retardance. In Comparative Example 1 in which a polypropylene resin having a flexural modulus of 1700 MPa was used in the flame-retardant resin layer, the bending strength was as high as 60 g, showing poor flexibility although the thermal resistance and flame retardance was satisfactory. In Comparative Example 2 in which a polyester resin was used in both the flame-retardant resin layer and the resin layers exhibited good flexibility and flame retardance but poor thermal resistance. In Comparative Example 3 in which a polypropylene resin having a flexural modulus of 80 MPa was used in the flame-retardant resin layer exhibited good flexibility and flame retardance but poor thermal resistance. These results show that flat cables that use insulating films of the present invention have all of thermal resistance, flexibility, and flame retardance.

### REFERENCE SIGNS LIST

1 resin film
2 anchor coat layer
3 first resin layer
4 flame-retardant resin layer
5 second resin layer
6 insulating film
7 conductor

1-6. (canceled)

7. An insulating film comprising a resin film, an anchor coat layer, and a flame-retardant resin layer stacked in that order, wherein the flame-retardant resin layer is composed of a resin composition that contains 60 parts by mass or more and 240 parts by mass or less of a flame retardant-imparting agent relative to 100 parts by mass of a polypropylene resin having a flexural modulus of 100 MPa or more and less than 900 MPa on the basis of Japanese Industrial Standard (JIS) K7171.

8. The insulating film according to claim 7, further comprising a first resin layer between the anchor coat layer and the flame-retardant resin layer.

9. The insulating film according to claim 7, further comprising a second resin layer on the flame-retardant resin layer.

10. The insulating film according to claim 8, further comprising a second resin layer on the flame-retardant resin layer.

11. The insulating film according to claim 9, wherein the second resin layer is mainly composed of an acid-modified polypropylene resin.

12. The insulating film according to claim 10, wherein the second resin layer is mainly composed of an acid-modified polypropylene resin.

13. The insulating film according to claim 10, wherein the first resin layer and the second resin layer each have a thickness of 1 μm or more and 10 μm or less.

14. The insulating film according to claim 12, wherein the first resin layer and the second resin layer each have a thickness of 1 μm or more and 10 μm or less.

15. A flat cable comprising the insulating film according to claim 7, wherein the insulating film is used as a coating material.

16. A flat cable comprising the insulating film according to claim 8, wherein the insulating film is used as a coating material.

17. A flat cable comprising the insulating film according to claim 9, wherein the insulating film is used as a coating material.

18. A flat cable comprising the insulating film according to claim 10, wherein the insulating film is used as a coating material.

19. A flat cable comprising the insulating film according to claim 11, wherein the insulating film is used as a coating material.

20. A flat cable comprising the insulating film according to claim 12, wherein the insulating film is used as a coating material.

21. A flat cable comprising the insulating film according to claim 13, wherein the insulating film is used as a coating material.

22. A flat cable comprising the insulating film according to claim 14, wherein the insulating film is used as a coating material.
